(19) United States
(12) Patent Application Publication
(10) Pub. No.: US 2003/0167881 A1
(43) Pub. Date: Sep. 11, 2003

(54) Collar clamping pliers

(76) Inventors: Eric Chauffeteau, Romorantin (FR); Cyriaque Fouqueray, Romorantin (FR); Didier Goussault, Romorantin (FR); Richard Chene, Maray (FR)

Correspondence Address: MASON & ASSOCIATES, PA, 17757 US HWY 19 N., SUITE 500, CLEARWATER, FL, 33764, US

(21) Appl. No.: 10/275,510

(22) PCT Filed: May 11, 2001
(86) PCT No.: PCT/FR01/01423

(51) Int. Cl. B25B 27/10

(52) U.S. Cl. 81/9.3

(57) ABSTRACT

A clamping collar having a hook (29) is suitable for engaging a lug (30). A first jaw (20) of the pliers is equipped with a retaining member (46) mounted to move relative to it between a retaining position in which it is capable of co-operating with the hook or with the lug to retain the hook or the lug against the jaw and a release position in which it releases the hook or the lug. Advantageously, each of the jaws is provided with such a retaining member, the two members being respectively suitable for being engaged under the hook and under the lug which, for this purpose, is provided with a recess.

The present invention relates to pliers designed to tighten a clamping collar which has two end portions provided respectively with a radial projection or “lug” and with a hook suitable for engaging said lug to tighten the collar, the pliers including two jaws suitable for co-operating respectively with the lug and with the hook, and for being moved towards each other to engage the hook on the lug.

Closing the pliers reduces the diameter of the collar by bringing the hook closer to the lug, until the hook passes over said lug and engages it. To tighten the collar, firstly it is put in place around the object to be clamped, in the open state, it is then positioned correctly, and then, the above-mentioned operation is performed with pliers.

In some cases, the collar must be positioned very accurately. This applies, for example, when the collar serves to clamp a pipe onto an end-piece in leaktight manner, which requires the tightening forces to be applied in a particular region of the end-piece, e.g. between two beads present on said end-piece. It can also be necessary for the collar to be angularly positioned in a particular manner on the pipe.

When the collar is disposed in the open state on the object to be clamped, it can move a little relative thereto, e.g. by turning about its axis. In addition, the collar can inadvertently be moved a little on disposing the jaws of the pliers respectively against the hook and against the lug. It is then necessary to put the collar back into place before it is tightened, or to hold it with one hand while tightening with the other hand.

In addition, the jaws of the pliers are usually merely placed respectively behind the hook and behind the lug. It is possible for an unfortunate manipulation error to be made during which the hook or the lug slips out of the jaw that was applied against it. In such a case, the entire tightening operation must be started again.

An object of the invention is to provide tightening pliers of the above-mentioned type, making it possible to facilitate the tightening operation by controlling better the positioning of the collar during the tightening, and by preventing the collar from slipping out of the jaws of the pliers.

This object is achieved by means of the fact that a first jaw is equipped with a retaining member that is mounted to move relative to it between a retaining position in which said retaining member is capable of co-operating with at least one of the elements constituted by the lug and by the hook to retain said element against said jaw, and a release position in which it releases said element relative to said jaw.

By means of these provisions, when the jaws of the pliers are applied against the collar, the hook or the lug is retained against the jaw with which it co-operates. This prevents the collar from slipping out of the pliers. Thus, if the collar is wrongly positioned, its position can be rectified by manipulating the pliers because the collar is temporarily secured to them by means of the retaining member. In addition, this prevents the jaw provided with the retaining member from slipping relative to the hook or to the lug during closing of the pliers.

Advantageously, the first jaw is provided with an abutment surface facing the second jaw, and the retaining member is disposed beyond said abutment surface in the direction going towards said second jaw.

Thus, when the jaw is disposed against one of the elements constituted by the hook and by the lug, said element comes into abutment against the abutment surface, and the retaining member, which is disposed in front of its abutment surface, retains said element in this position.

In an advantageous configuration, the retaining member is mounted to move transversely to the axis along which the jaws can be moved together or apart.

The retaining member can thus be disposed simply and compactly.

Advantageously, the pliers include resilient return means urging the retaining member continuously towards its retaining position.

In which case, whenever the jaw provided with the retaining member is disposed against one of the elements constituted by the lug or by the hook, said element automatically finds itself retained in said jaw by the retaining member being positioned automatically in its retaining position.

Advantageously, the pliers include an urging member capable, during closing of the pliers, of co-operating with the retaining member to urge said retaining member into its release position.

In which case, the retaining member being released relative to the element (hook or lug) that it retains also takes place automatically merely by means of the pliers being closed. Preferably, the urging member is disposed such that the retaining member reaches its release position only when the pliers are closed. This increases the safety of the tightening, by preventing the pliers from separating from the collar so long as said collar is not correctly clamped.

Advantageously, the retaining member is formed by a lever pivotally mounted on the first jaw.

The pivotally-mounted lever, e.g. in the form of a claw, constitutes a particularly simple embodiment.

Advantageously, each of the jaws is provided with an analogous retaining member.

Since the hook and the lug have a matching configuration, each of these two projecting elements can be retained against a respective one of the two jaws. In addition, if the jaws are substantially identical, it is possible to apply either one of them against the hook or against the lug, without one jaw being specially adapted for the hook and the other being specially adapted for the lug.

In an advantageous embodiment, the jaws are mounted on respective ones of first and second support arms so that they are capable of pivoting relative to said arms about an angular positioning axis that is substantially parallel to the axis along which the jaws are moved together or apart.

The clearance around the object to be clamped can be insufficient to enable the pliers to be brought towards it in a radial plane that is perpendicular to the axis of the collar. Or, quite simply, for various practical reasons, the user might wish to position the pliers angularly relative to such a radial plane. This is made possible by means of the capacity of the jaws to pivot on their support arms.

For example, it is possible to dispose the pliers normally about the collar and to position the pliers angularly so as to place them in a position in which tightening is more practical. It is also possible for the jaws to be angularly positioned in a suitable position for facilitating bringing the pliers towards the collar.

In which case, the pliers preferably include means for constraining the two jaws to move together as they pivot about the angular positioning axis.

This constraining the jaws to pivot together means that, when one jaw is pivoted about its angular-positioning pin, the other jaw pivots simultaneously about its own angular positioning pin, through the same angle.

These means for constraining the two jaws to pivot together make the pliers much easier to manipulate since they guarantee that the two jaws always have the same angular position.

Advantageously, the two jaws are constrained to pivot together by a hinged coupling pin that is capable of taking up a deployed position when the jaws are spaced apart, and a folded-up configuration when the jaws are clamped together.

This hinged coupling pin constitutes simple means for constraining the two jaws to pivot together, and does not hinder closing of the pliers in any way.

The invention will be well understood and its advantages will appear more clearly on reading the following detailed description of an embodiment shown by way of non-limiting example. The description is given with reference to the accompanying drawings, in which:

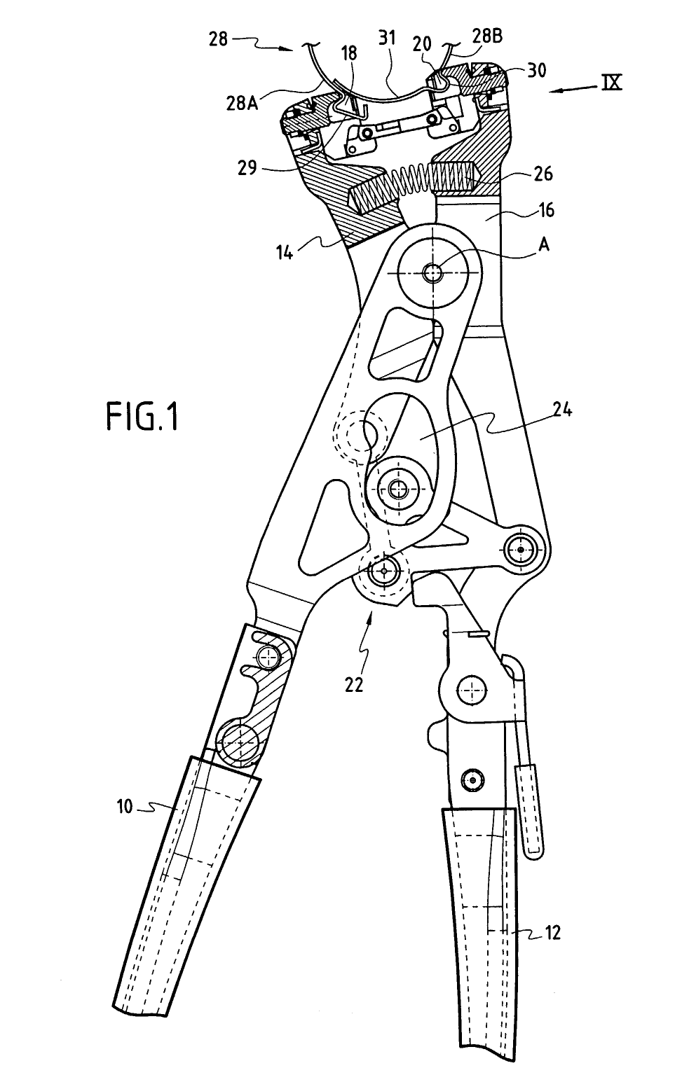

FIG. 1 is an elevation view of pliers of the invention, looking along the pivot axis about which the arms of the pliers pivot, the jaws and the end portions of the arms that carry them being shown in section in a plane perpendicular to the pivot axis of said arms, a clamping collar being shown in part and engaged in the jaws, said jaws being shown in the open position of the pliers;

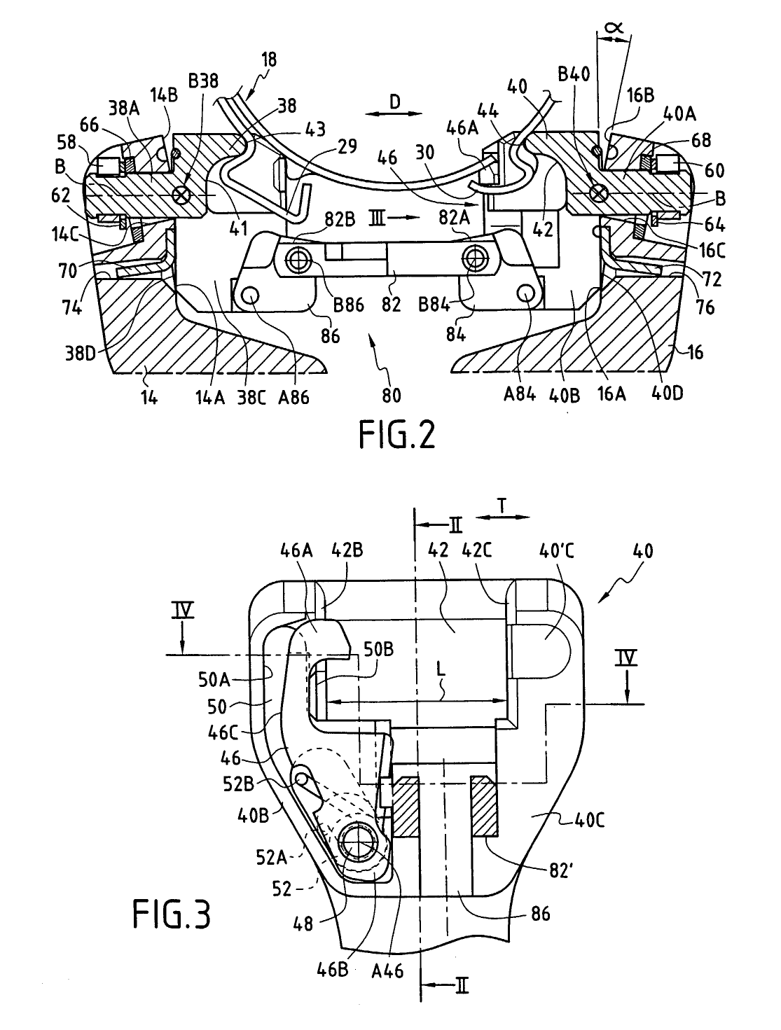

FIG. 2 is an enlarged view of the jaws, on the same section as in FIG. 1;

FIG. 3 is a view looking along arrow III of FIG. 2;

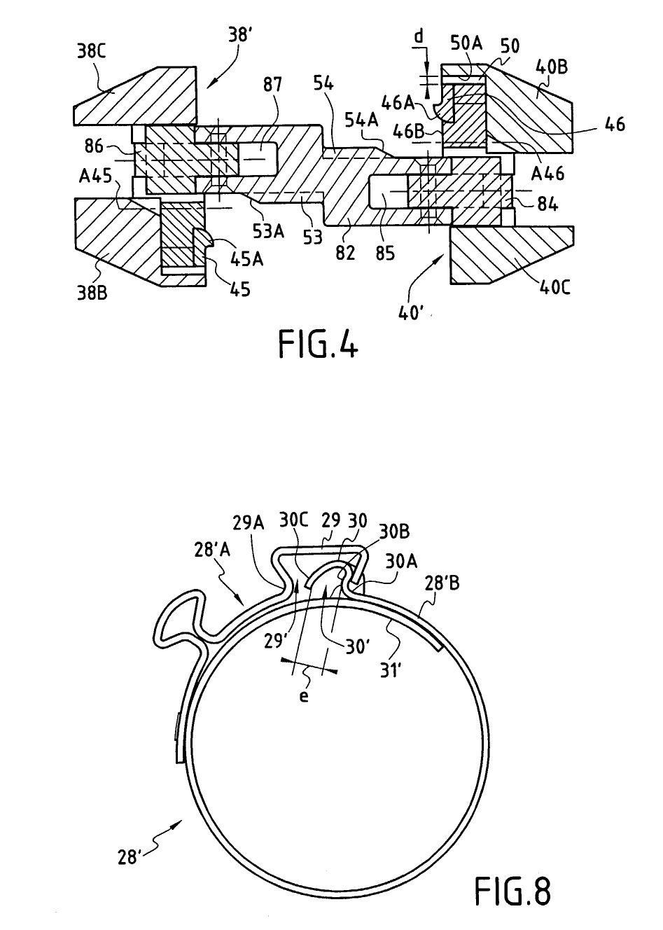

FIG. 4 is a section view on line IV-IV of FIG. 3;

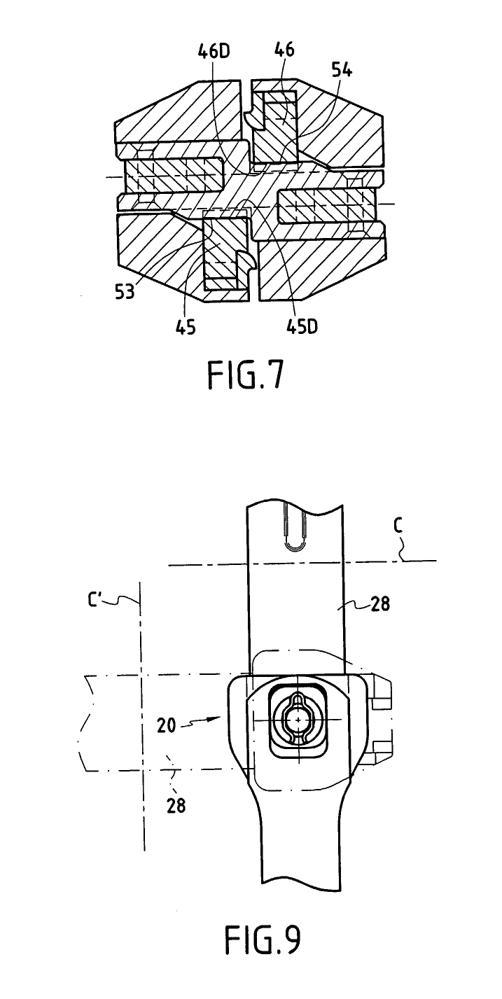

FIGS. 5, 6, and 7 correspond respectively to FIGS. 2, 3, and 4 for the closed position of the jaws of the pliers;

FIG. 8 diagrammatically shows a clamping collar tightened by means of the pliers of the invention; and

FIG. 9 is a diagrammatic fragmentary view looking along arrow IX of FIG. 1.

The pliers shown in FIG. 1 include two actuating arms 10 and 12 mounted to pivot relative to each other about an axis A. The pliers also include two support arms 14 and 16, each of which carries a respective jaw 18 and 20. In the example shown, the pliers have a system for multiplying the force they apply, the support arm 16 extending in alignment with the actuating arm 12, while the support arm 14 is connected to arms 12 and 16 via a link system 22 which is itself connected to the actuating arm 10 via a cam system 24.

The present invention relates to the jaws of the pliers, and it should be understood that it applies to pliers that do not have force-multiplying systems, or to pliers that have force-multiplying systems that are different from the system shown.

As shown in FIG. 1, the pliers are open and their jaws are spaced apart. The pliers are urged into this open position by a return spring 26 disposed between the arms 14 and 16.

A clamping collar 28 of which the two end portions can be seen is disposed between the jaws of the pliers. A first end portion 28A carries a hook 29 while the second end portion 28B carries a lug 30. To tighten the collar, it is necessary to engage the hook 29 on the lug 30, as can be seen in FIG. 8.

In the example shown in FIG. 1, the collar 28 is provided with an extension 31 or “tip” that extends the end portion 28B beyond the lug 30.

The collar 28′ of FIG. 8 is of the type described in EP 0 724 106. It includes a first strip portion which, at its first end 28′B, carries the lug 30 and which, at its second end, carries the tip 31′. The hook 29 is formed on an end portion 28′A of another strip portion which is mounted on the first strip portion. In FIG. 2, it is a collar of this type that is engaged in the jaws.

Each of the jaws 18 and 20 includes a respective jaw piece 38, 40 which is fixed by a stud 38A, 40A to the corresponding support arm 14 or 16, and which has two respective cheeks 38B & 38C or 40B & 40C.

Jaw 20 is described in more detail, since jaw 18 is identical to it. Below, it is considered that the front face of a jaw is that one of its faces which faces towards the other jaw, while the back face is opposite from it.

The front face of the jaw piece 40 is provided with a setback 42 defined at its top by an overhang zone 44. The surface of said zone 44 forms an abutment surface for the base 30A of the lug 30 or for the base 29A of the hook 29 (see FIG. 8). By way of example, FIG. 2 shows how the collar co-operates with the jaws of the pliers, by disposing the lug 30 in engagement with the jaw 40 and the hook 29 in engagement with the jaw 38. It can be seen that the back portions of the hook and of the lug are engaged in respective ones of the setbacks 42 and 41 with which the jaws are provided, and that their respective bases are in abutment against the respective abutment surfaces 44 and 43.

Each of the jaws includes a retaining member, respectively 45 for jaw 18 and 46 for jaw 20. They are both visible in FIG. 4. The retaining member 46 that is secured to the jaw 20 is described in more detail below. It is constituted by a lever whose free end is in the form of a claw 46A suitable, as shown in FIG. 2, for being engaged under the lug 30 when said lug is in engagement with the jaw 20. The base 46B of the lever, i.e. its end opposite from the free end 46A, is pivotally mounted on the jaw 20 to pivot about a pivot axis A46. More precisely, the base of the lever is fixed to the cheek 40B of the jaw piece 40 by a stud or the like 48.

It can be seen in FIG. 2 that the retaining element 46 is spaced apart from the abutment surface 44 going towards the jaw 18. Thus, a space is provided between said abutment surface and the retaining element for the purpose of receiving at least the thickness of the collar in the zone of the base of the hook or of the lug. In certain cases, as in the example shown, the base of the lug has a projection, and it is also taken into account in the spacing between the retaining member and the abutment surface.

The double-headed arrow D of FIG. 2 indicates the axis along which the jaws move relative to each other to close or to open the pliers. The axis A46 about which the lever 46 pivots extends parallel to said axis D, so that the lever is moved transversely to said axis D.

FIG. 3 shows the lever 46 in its active retaining position. The width L of the setback 42 corresponds substantially to the width of the hook 29 or of the lug 30, as measured in the axial direction of the collar. When the hook or the lug co-operates with a jaw, it is wedged along the transverse axis T of the jaw by the side surfaces 42B and 42C that define the setback 42 in each of the cheeks 40B and 40C.

It can be understood that, in this situation, the free end 46A of the lever 46 is engaged under the hook or under the lug. In the retaining position, the free end 46A projects from the surface 42B towards the surface 42C. The lever 46 is received in a cavity 50 provided in the cheek 40B of the jaw piece 40. It can be seen that, in the retaining position shown, in particular, in FIGS. 3 and 4, the back 46C of the lever 46, i.e. the surface of said lever that is remote from the setback 42, is spaced apart by a distance d from the wall 50A which defines the cavity 50 on the side opposite from the cheek 40C. On the other side, the lever is retained by an abutment 50B formed on that face of the cavity 50 which is opposite from the face 50A. The abutment 50B limits the stroke of the lever going into the setback 42 (i.e. towards the cheek 40C).

The lever 46 is urged continuously towards its retaining position by resilient return means constituted, in the example shown, by a spring 52 which is disposed around the stud 48, and which has a first end 52A in abutment against the wall 50A of the cavity 50, and its other end 52B co-operating with the back of the lever.

The lever 45 with which the other jaw 18 is provided is mounted in the same way as the lever 46, on the cheek 38B of the jaw piece 38. it is therefore also mounted to pivot about an axis A45 parallel to the axis D. The two jaws 18 and 20 are identical and they are disposed such that the cheek 38B provided with the lever 45 finds itself facing the cheek 40C that is not provided with the lever, and such that the cheek 40B provided with the lever 46 faces the cheek 38C that is not provided with a retaining lever. In the example shown, each jaw is equipped with a single retaining member.

By means of the above-described configuration, the retaining lever 45 is capable of co-operating with one of the fastening elements, e.g. the hook 29 of the collar, on a first longitudinal edge of the collar, while the other retaining lever 46 cooperates with the other fastening element (the lug 30 in this example) on the other longitudinal edge of the collar. Thus, the lug and the hook are prevented from being extracted from the jaws of the pliers by causing the collar to tilt about a diametral plane of said collar parallel to the axis D.

FIGS. 5 to 7 shows the situation when the pliers are closed. The two jaws are moved together so that the front ends 38′ and 40′ of the jaw pieces 38 and 40 defined respectively by the front ends of the cheeks 38B and 38C and by the front ends of the cheeks 40B an 40C are in contact.

This contact is not hindered by the fact that the free ends 45A and 46A of the lever 45 and 46 project slightly forwards from the jaw pieces that carry them. The front face of the cheek 40C is provided with a small setback 40° C. serving to receive the projecting portion of the free end 45A of the lever 45. An analogous setback 38° C. is provided in the cheek 38C and it can be seen in FIG. 5 that it receives the projecting portion of the free end 46A of the lever 46.

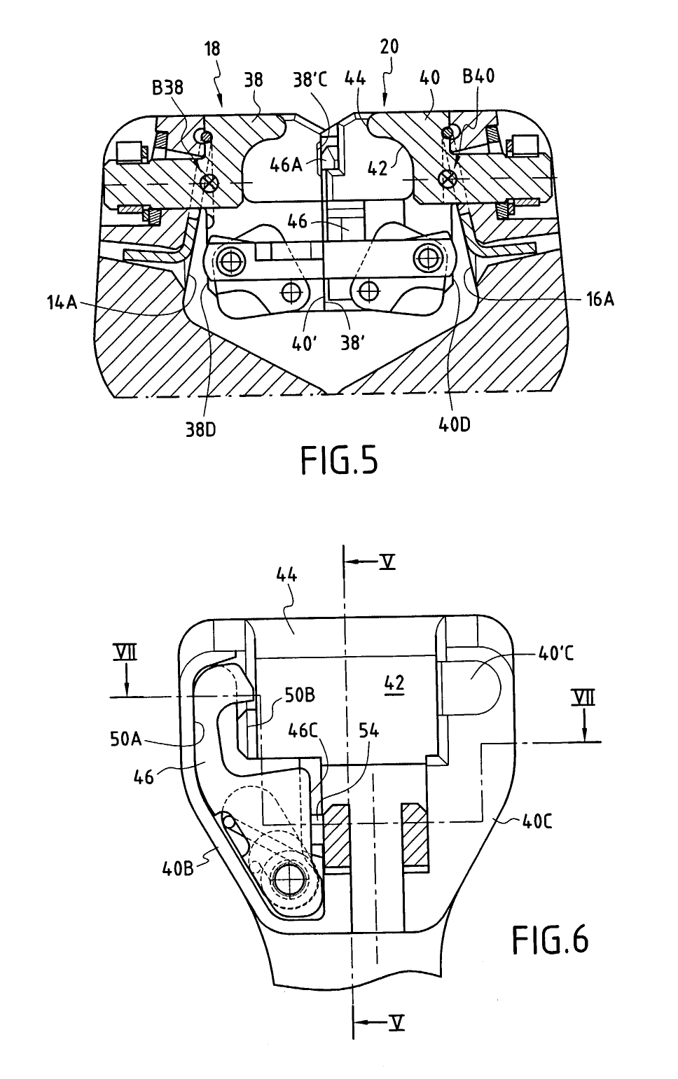

In the situation shown in FIGS. 5 to 7, the retaining levers occupy their respective release positions. This can be seen more clearly in FIG. 6 which shows that the lever 46 is retracted into the cavity 50, the back of said lever being situated against the wall 50A.

The lever 46 is brought into this release position by an urging member 54 which, during closing of the pliers, causes said lever to pivot by causing it to retract into the cavity 50. Similarly, an urging member 53 brings the lever 45 into its release position during closing of the pliers.

The urging members co-operate with the respective retaining members as the pliers are being closed. They are preferably disposed such that the two retaining members can occupy their release positions both at the same time only when the pliers are indeed closed. For example, the urging member co-operating with the lever 46 of the jaw 20 may be a part belonging to the other jaw 18 or else, as in the example, shown, an accessory part. Likewise, the urging member 53 may belong to the jaw 18 or to an accessory part.

It is also possible to make provision for the retaining members (the levers 45 and 46 in this example) to be urged towards their release positions by parts belonging to the collar. Thus, the retaining member that co-operates with the hook could be urged into the release position by the lug, when said lug is engaged under the hook, while the other retaining member, which co-operates with the lug, could be urged into the release position by the hook arriving over the lug.

By comparing FIGS. 2 and 5, it can be noted that, during closing of the pliers, the jaws tilt so as to stand up towards the center of the collar. Thus, the jaw pieces 38 and 40 pivot through an angle of a few degrees, respectively about an axis B38 and about an axis B40, these axes being perpendicular to the axis B mentioned below.

In FIG. 2, the rear faces 38D and 40D of the jaw pieces 38 and 40 are in abutment against respective ones of the first abutment faces 14A and 16A of the abutment arms 14 and 16.

In contrast, in FIG. 5, the back faces 38D and 40D are spaced apart from the first abutment faces 14a and 16A but they are in abutment against the second abutment faces, respectively 14B and 16B, which are inclined relative to the first abutment faces by an angle □. During tightening of the collar, the hook 29 and the lug 30 move relative to each other by turning over a circle whose center corresponds substantially to the geometric center of the collar.

If the jaws were fixed relative to the support arms 14 and 16, they would move relative to each other over a circle whose center is the axis A, which is naturally situated on the other side of the collar relative to the geometric center thereof

Therefore, during tightening of the collar, the hook and the lug, and both jaws, would tend to move over respective circles of opposite curvatures. The capacity of the jaws to tilt relative to each other about respective ones of the axes B38 and B40 enables them to move with the hook and with the lug as they move relative to each other, while holding the collar firmly, i.e. the tilting enables them also to move over the circle formed by the collar.

To make this tilting possible, the studs 38A and 40A for fixing the jaws are mounted with clearance in respective bores 14C and 16A in the support arms. The studs 38A and 40A are held in the bores by respective spring clips 58 and 60 which hold respective locking washers 62 and 64, in abutment against respective abutment washers 66 and 68, in abutment against the shoulders defined by the bores 14C and 16C on the backs of the abutment arms.

It is possible to replace the spring clips and the washers by spring washers, through which the studs pass and which are pressed by metal clips against the back faces of the support arms, in which faces the bores 14C and 16C to open out, said washers deforming to enable the studs to tilt.

As can be seen in FIG. 2, the jaws are continuously urged back into their abutment position in which they abut against the first abutment faces 14A and 16A by respective springs 70 and 72, whose ends bear against respective bores 74 and 76 in the abutment arms, and which are wound around the studs 28A and 48A to form at least one turn in abutment against the backs of the jaw pieces.

The jaws can also be angularly positioned by pivoting about an angular positioning axis B defined by the axis D along which the jaws move together and apart. Thus, FIG. 9 shows in uninterrupted lines the jaws disposed in alignment with the support arms of the pliers, for tightening a collar 28 whose geometric axis C is parallel to the hinge axis A of the coupling pin, itself perpendicular to the angular positioning axis B of the arms of the pliers. The jaws can pivot about the axis B to tighten a collar that is angularly positioned differently, e.g. as indicated in chain-dotted lines in FIG. 9, a collar whose geometric axis C′ is perpendicular to the axis A.

In the invention, the pliers include means for coupling the two jaws 18 and 20 to constrain them to pivot together about the angular positioning axis B. In the preferred embodiment shown, these means are formed by a hinged coupling pin that connects the jaws together, the hinges of the pin naturally not being parallel to the axis B. The hinged coupling pin 80 can take up a deployed configuration when the pliers are in the open position (FIG. 2), and a folded-up configuration when the pliers are in the closed position (FIG. 5). In FIGS. 2 and 5, the jaw pieces are shown in section, but the coupling pin is shown from the outside.

To avoid hindering closing of the pliers and tightening of the collar, the hinged coupling pin 80 is disposed in a region of the jaws that is situated between their abutment surfaces that co-operate with the collar and the hinge axis A of the coupling pin perpendicular to the angular positioning axis of the pliers. It is also possible to provide a sliding rod system for coupling the jaws to constrain them to pivot together about the axis B.

In the example shown, the coupling pin has a rigid pin segment 82 which is connected to each of the jaws via a respective link 84, 86. Thus, the link 84 is fixed between the two cheeks 40B and 40C of the jaw piece 40 so that it can pivot relative to said jaw piece about an axis A84, perpendicular to the axis B. A first end 82A of the pin segment 82 is fixed to said link 84 so that it can pivot relative to it about an axis B84 parallel to the axis A84. Similarly, the link 86 is disposed between the cheeks 38B and 38C so that it can pivot about an axis A86, while the end 82B of the pin segment is fixed to it so that it can pivot about an axis B86.

When the jaws are in the position shown in uninterrupted lines in FIG. 9, the axes A84, B84, A86, and B86 are parallel to the hinge axis A of the coupling pin perpendicular to the angular positioning axis of the pliers. The deployed configuration of the hinged pin 80 is defined by the bottom face 82′ of the pin segment 82 (face remote from the abutment surfaces 44 and 43) coming into abutment with abutment surfaces formed on the cheeks 40B and 40C of the jaw piece 40 and on the cheeks 38B and 38C of the jaw piece 38 (FIG. 3).

In this position, the links 84 and 86 are disposed such that the axes B84 and B86 are as far away as possible from the back faces of the jaw pieces that carry them. When the pliers are closed, the hinged pin goes into its folded-up configuration, by means of the links 84 and 86 pivoting so as to bring the axes B84 and B86 closer to respective ones of said back faces, until the position shown in FIG. 5 is reached.

The pin segment 82 is provided with slots 85 and 87 making it possible for the links to fold up through them. As indicated above, by means of urging members 53 and 54, the levers 45 and 56 are brought into their release configuration when the pliers are closed.

In the advantageous example, the urging members are formed on the hinged coupling pin and, more precisely on the pin segment 82. When the pliers are closed, the longitudinal edges (parallel to the axis B) of the pin segment 82 move against the urging surfaces (respectively 45D and 46D) belonging respectively to the levers 45 and 46. The actuating members are formed by bulges, formed on the longitudinal edges of the pin segment 82, and whose ends 53A and 54A that are the first surfaces to come into contact with the actuating surfaces of the levers 45 and 46 are ramp-shaped.

By comparing FIGS. 3 and 6, it can be understood that, when the pin segment 82 moves towards its folded-up position, the bulge 54 slides against the actuating face 46D of the lever 46 until said lever is brought into its folded-up position shown in FIG. 5, the two bulges 53 and 54 co-operating respectively with the lever 45 and with the lever 46, so that said two retaining levers are in their release positions. The collar, whose hook has engaged the lug can then be extracted from the jaws.

Preferably, to facilitate inserting the collar between the jaws prior to closing the pliers, the retaining lever 46 has a ramp surface that co-operates with one of the elements constituted by the hook and by the lug of the collar when said element is pushed back towards the abutment surface 44, to lead the lever to retract until said element rests on said abutment surface. In this situation, the lever can take up its retaining position again. For this purpose, the ends 45A and 46A of the levers 45 and 46 are rounded.

In the example shown, the two jaws of the pliers are identical. Thus, the hook 29 and the lug 30 are both retained by said retaining levers in the jaws of the pliers.

A recess 29′ is provided under the hook 29, making it possible to insert the active free end 45A of the lever 45 under the hook. The fold forming the back of the hook is thus in abutment against the abutment surface 43 and cannot be extracted forwards because its front face is retained by the retaining lever 45.

The collar to be tightened by the pliers of the invention is also provided with a recess 30′ provided under the lug. It can be seen in FIG. 8 that the lug 30 is slightly “open”. The two folds 30B and 30A that define said lug are spaced apart in order to provide the recess 30′ between them. The inside faces of the two folds are spaced apart by a distance d at least equal to the thickness of the active free end of the lever 45 or of the lever 46.

We claim:

1. Pliers designed to tighten a clamping collar (28; 28′) which has two end portions (28A, 28B; 28′A, 28′B) provided respectively with a radial projection or “lug” (30) and with a hook (29) suitable for engaging said lug to tighten the collar, the pliers including two jaws (18; 20) suitable for co-operating respectively with the lug and with the hook, and for being moved towards each other to engage the hook on the lug;
said pliers being characterized in that a first jaw (18; 20) is equipped with a retaining member (45; 46) that is mounted to move relative to it between a retaining position (FIG. 3) in which said retaining member is capable of co-operating with at least one of the elements constituted by the lug (30) and by the hook (29) to retain said element against said jaw, and a release position (FIG. 6) in which it releases said element relative to said jaw.

2. Pliers according to claim 1, characterized in that the first jaw (18; 20) is provided with an abutment surface (43; 44) facing the second jaw (20; 18), and in that the retaining member (45; 46) is disposed beyond said abutment surface in the direction going towards said second jaw.

3. Pliers according to claim 1 or 2, characterized in that the retaining member (45; 46) is mounted to move transversely (T) to the axis (D) along which the jaws (18; 20) can be moved together or apart.

4. Pliers according to any one of claims 1 to 3, characterized in that they include resilient return means (52) urging the retaining member (45; 46) continuously towards its retaining position.

5. Pliers according to any one of claims 1 to 4, characterized in that they include an urging member (53; 54) capable, during closing of the pliers, of cooperating with the retaining member (45; 46) to urge said retaining member into its release position (FIG. 6).

6. Pliers according to any one of claims 1 to 5, characterized in that the retaining member is formed by a lever (45; 46) pivotally mounted (A45; A46) on the first jaw (18; 20).

7. Pliers according to any one of claims 1 to 6, characterized in that the jaws (18; 20) are mounted on respective ones of first and second support arms (14; 16) so that they are capable of pivoting relative to said arms about an angular positioning axis (B) that is substantially parallel to the axis (D) along which the jaws are moved together or apart.

8. Pliers according to claim 7, characterized in that they include means (80) for constraining the two jaws (18; 20) to move together as they pivot about the angular positioning axis (B).

9. Pliers according to claim 8, characterized in that the two jaws are constrained to pivot together by a hinged coupling pin (80) that is capable of taking up a deployed position (FIG. 2) when the jaws (18; 20) are spaced apart, and a folded-up configuration (FIG. 5) when the jaws are clamped together.

10. Pliers according to claim 9, characterized in that the coupling pin (80) comprises a rigid pin segment (82) connected to each of the two jaws (18; 20) by a respective link (84; 86).

11. Pliers according to claim 5 and according to claim 9 or claim 10, characterized in that the urging member (53; 54) is secured to the coupling pin (80).

12. Pliers according to any one of claims 1 to 11, characterized in that the two jaws (18; 20) are identical.

13. A kit comprising pliers according to any one of claims 1 to 12, and a clamping collar (28) to be tightened by means of pliers;
characterized in that the lug (30) has two folds (30B; 30C) spaced apart from each other so as to provide a recess (30′) between them, in which the retaining member (45, 46) can be received.
